(19) United States
(12) Patent Application Publication
(10) Pub. No.: US 2015/0294287 A1
(43) Pub. Date: Oct. 15, 2015

(54) METHOD AND SYSTEM FOR IMPLEMENTING POINT OF SALE MOBILE CONVERSION KEY

(71) Applicant: MASTERCARD INTERNATIONAL INCORPORATED, Purchase, NY (US)

(72) Inventor: Garry LYONS, Dublin (IE)

(73) Assignee: MASTERCARD INTERNATIONAL INCORPORATED, Purchase, NY (US)

(21) Appl. No.: 14/248,820

(22) Filed: Apr. 9, 2014

(51) Int. Cl. G06Q 20/20; H04W 4/00; H04W 76/02; G06Q 20/32; G06Q 20/40

(52) U.S. Cl. CPC G06Q 20/202; G06Q 20/3278; G06Q 20/40; H04W 76/02; H04W 4/008

(57) ABSTRACT

A method for processing a contactless payment transaction using a traditional point of sale includes: coupling, to a point of sale device, a removable computing device; detecting, by the removable computing device, an external computing device; establishing, by the removable computing device, communication with the external computing device by a wireless communication protocol; receiving, by a receiver of the removable computing device, payment details associated with a payment account; formatting, by a processor of the removable computing device, the received payment details for inclusion in an authorization request for a payment transaction; and transmitting, by a transmitter of the removable computing device, the formatted payment details to the point of sale device.

### FIELD

The present disclosure relates to the processing of contactless payment transactions using a traditional point of sale, and more specifically the use of a removable computing device selectively coupleable to a traditional point of sale to enable contactless payment transactions with a consumer mobile device.

### BACKGROUND

As cellular phones, smart phones, and other similar mobile computing devices experience increased use by consumers, methods and systems have been developed to make conducting payment transactions with such devices easier and more efficient. In one such example, wallet applications for mobile devices have been designed, which can enable a consumer to use their mobile device in place of a traditional payment card in order to pay for a payment transaction. However, in order for a merchant point of sale to read payment details from the mobile device, some form of communication between the points of sale and the mobile device needs to be established.

Common methods that have been developed for transferring payment details from the mobile include using near field communication (NFC) or other similar form of short range communication, such as Bluetooth, Wi-Fi, ZigBee, etc. to communicate between the mobile device and the point of sale. However, traditional point of sale systems are often not equipped to be able to communicate using such contactless protocols and networks. As a result, many merchants can be unable to offer this convenience to their consumers without requiring a significant expense on behalf of the merchant or other party in the payment chain to upgrade their point of sale systems to ones where such technology is available.

Thus, there is a perceived need for a technical solution to enable traditional point of sale systems to process contactless payment transactions with a mobile device.

### SUMMARY

The present disclosure provides a description of systems and methods for the processing of contactless payment transactions using a traditional point of sale.

A method for processing a contactless payment transaction using a traditional point of sale includes: coupling, to a point of sale device, a removable computing device; detecting, by the removable computing device, an external computing device; establishing, by the removable computing device, communication with the external computing device by a wireless communication protocol; receiving, by a receiver of the removable computing device, payment details associated with a payment account; formatting, by a processor of the removable computing device, the received payment details for inclusion in an authorization request for a payment transaction; and transmitting, by a transmitter of the removable computing device, the formatted payment details to the point of sale device.

Another method for processing a contactless payment transaction using a traditional point of sale includes: coupling, to a point of sale device, a removable computing device; detecting, by the removable computing device, an external computing device; establishing, by the removable computing device, communication with the external computing device by a wireless communication protocol; receiving, by a receiving device, payment details associated with a payment account; generating, by a processing device, an authorization request for a payment transaction, wherein the authorization request includes at least the received payment details; and transmitting, by a transmitter of the point of sale device, the generated authorization request.

A system for processing a contactless payment transaction using a traditional point of sale includes a point of sale device, and a removable computing device coupled to the point of sale device. The removable computing device is configured to: detect an external computing device; and establish communication with the external computing device by a wireless communication protocol. The removable computing device includes: a receiver configured to receive payment details associated with a payment account; a processor configured to format the received payment details for inclusion in an authorization request for a payment transaction; and a transmitter configured to transmit the formatted payment details to the point of sale device.

Another system for processing a contactless payment transaction using a traditional point of sale includes a point of sale device, a removable computing device coupled to the point of sale device, a receiving device, and a processing device. The removable computing device is configured to: detect an external computing device; and establish communication with the external computing device by a wireless communication protocol. The receiving device is configured to receive payment details associated with a payment account. The processing device is configured to generate an authorization request for a payment transaction, wherein the authorization request includes at least the received payment details. The point of sale device includes a transmitter configured to transmit the generated authorization request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for processing a contactless payment transaction using a traditional point of sale in accordance with exemplary embodiments.

FIG. 2 is a block diagram illustrating the removable computing device of FIG. 1 for the receiving and processing payment details in a contactless payment transaction in accordance with exemplary embodiments.

FIGS. 3 and 4 are flow diagrams illustrating high level processes for processing a contactless payment transaction in a traditional point of sale using the system of FIG. 1 accordance with exemplary embodiments.

FIGS. 5-7 are flow diagrams illustrating methods for processing contactless payment transactions using an external computing device and a traditional point of sale in accordance with exemplary embodiments.

FIGS. 8 and 9 are flow charts illustrating exemplary methods for processing contactless payment transactions using a traditional point of sale in accordance with exemplary embodiments.

FIG. 10 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

### System for Processing Contactless Payment Transactions at a Traditional Point of Sale

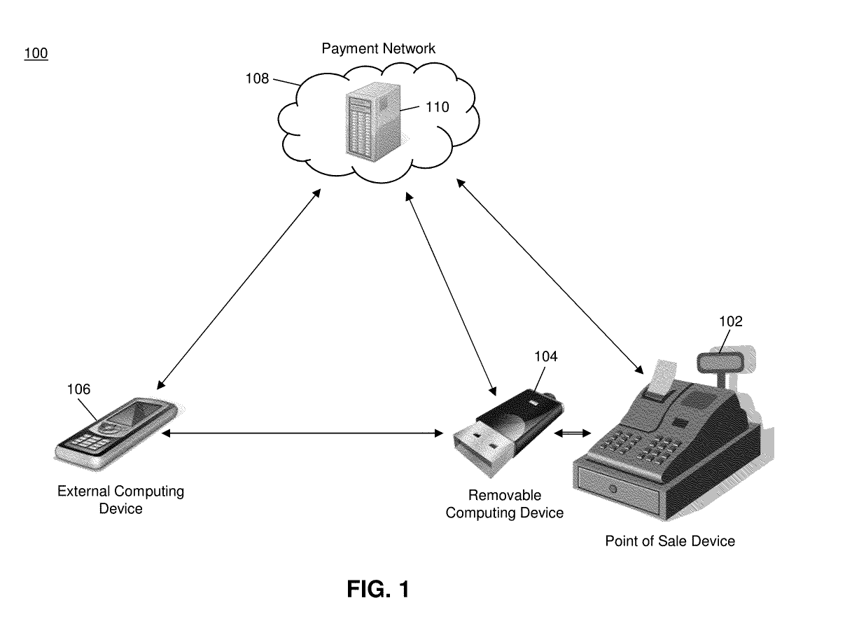

FIG. 1 illustrates a system 100 for the processing of contactless payment transactions at a traditional point of sale utilizing a removable computing device coupled therein.

The system 100 may include a point of sale device 102. The point of sale device 102 may be a traditional point of sale device configured to conduct payment transactions. The point of sale device 102 is an interface that is used to conduct a transaction with a consumer, and may be a conventional point of sale terminal, a mobile point of sale device, vending machine or other self-help terminal that might be distributed among inventory or at a given location, may be directly part of a point of sale system (e.g., the merchant's system associated with inventory, loyalty, etc.), a point of sale server, a magnetic strip swipe or chip card reader used as an adjunct device to a cash register, with or without manual keypad, or any other computing device configured to conduct payment transactions suitable for performing the functions (and possibly others) as disclosed herein.

The conducting of payment transactions may include the input of product data, such as by reading universal product codes from products or receiving input by a user, the generating of transaction details, the reading of payment details from a traditional physical payment card (e.g., via a magnetic strip), and the transmitting of transaction data and payment details to a payment network or acquirer for processing of the payment transaction.

In an exemplary embodiment, the point of sale device 102 may be unable to conduct a contactless payment transaction. A contactless payment transaction, as will be apparent to persons having skill in the relevant art, may be a payment transaction involving a point of sale device and a second device, in which payment details are transmitted from the second device to the point of sale device without physical contact between the two devices.

In order to modify the point of sale device 102 to be able to process contactless payment transactions, a removable computing device 104 may be removeably coupled to the point of sale device 102. The removable computing device 104, discussed in more detail below, may be a computing device that is configured to establish and conduct communications with an external computing device 106 for the purpose of carrying out a contactless payment transaction. The removable computing device 104 may be coupled to the point of sale device 102 using methods and systems that will be apparent to persons having skill in the relevant art, such as a universal serial bus port, a serial port, peripheral component interconnect, or other suitable coupling.

The removable computing device 104, when coupled to the point of sale device 102, may be configured to establish a communication channel with the external computing device 106. The external computing device 106 may be any type of mobile computing device suitable for performing the functions disclosed herein, such as a cellular phone, smart phone, tablet computer, laptop computer, notebook computer, wearable computing device, etc. The external computing device 106 may include at least some form of identification of a consumer associated thereby.

Payment details may be transmitted from the external computing device 106 to the removable computing device 104 using the established communication. The removable computing device 104 may then provide the payment details to the point of sale device 102 via the coupling. The point of sale device 102 may utilize the payment details using traditional methods to generate and transmit (e.g., via an acquirer) an authorization request for the payment transaction to a payment network 108.

A processing server 110 of the payment network 108 may receive the authorization request and may process the payment transaction using methods and systems that will be apparent to persons having skill in the relevant art. An authorization response indicating approval or denial of the processing transaction may subsequently be transmitted to the point of sale device 102 using traditional methods, and the payment transaction finalized accordingly.

In some embodiments, the payment details may be provided to the removable computing device 104 via the processing server 110 of the payment network 108. In such an embodiment, as discussed in more detail below, the external computing device 106 may transmit an indication of the payment transaction being conducted to the processing server 110. The indication may include identifying information of the removable computing device 104 or other suitable information for identifying a destination of the requested payment details. The processing server 110 may identify payment details (e.g., associated with the external computing device 106 or a user thereof) and may transmit the payment details to the removable computing device 104. The removable computing device 104 may then transmit the payment details to the point of sale device 102 via the physical coupling, and the transaction may be processed as discussed above.

The use of the removable computing device 104 to be removeably coupled to the point of sale device 102 and to establish communication with the external computing device 106 may enable the point of sale device 102 to process contactless payment transactions that it would otherwise be unable to. As such, the removable computing device 104 may enable a merchant to provide additional services to consumers, such as payment via contactless payments, without the expense of upgrading point of sale devices 102. In some instances, the removable computing device 104 may be able to deploy a software update to the point of sale device 102 to further accommodate the processing of contactless payment transactions, such as software that enables the point of sale device 102 to identify the payment details received from the removable computing device 104 as payment details read in the usual course of business. In such an instance, the point of sale device 102 may process the contactless payment transaction as a card swipe transaction, chip transaction, and/or any other type of traditional payment transaction.

### Removable Computing Device

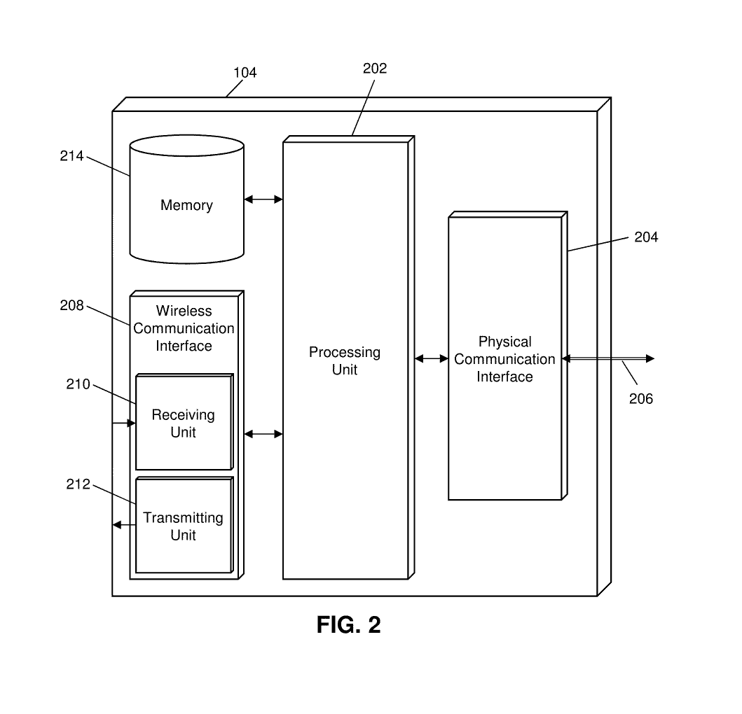

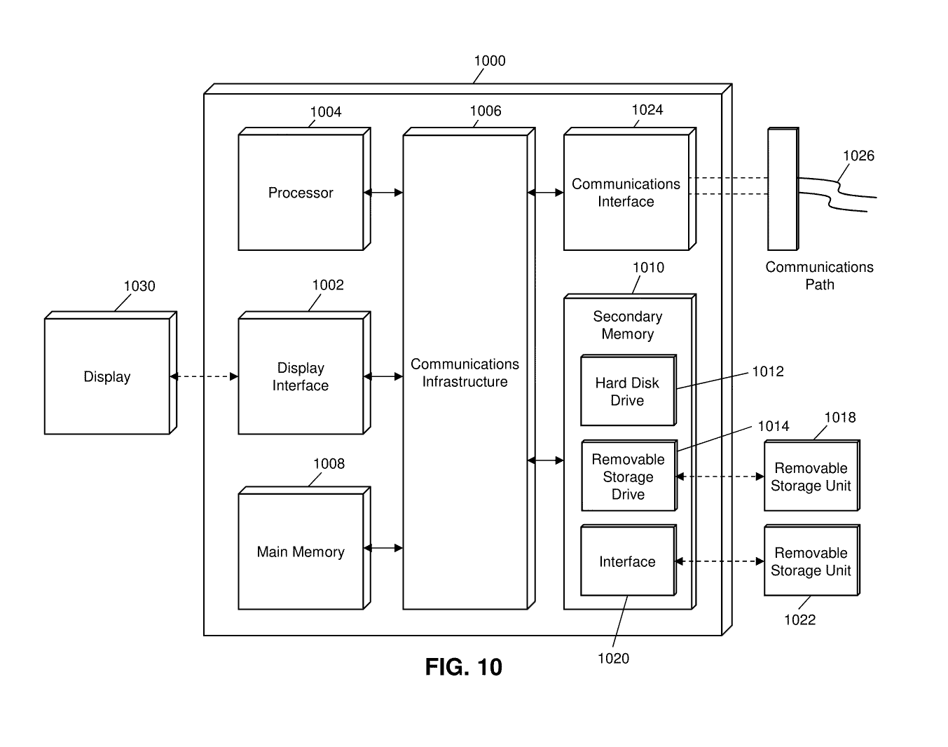

FIG. 2 illustrates an embodiment of the removable computing device 104 of the system 100. It will be apparent to persons having skill in the relevant art that the embodiment of the removable computing device 104 illustrated in FIG. 2 is provided as illustration only and may not be exhaustive to all possible configurations of removable computing device 104 suitable for performing the functions as discussed herein. For example, the computer system 1000 illustrated in FIG. 10 and discussed in more detail below may be a suitable configuration of the removable computing device 104.

The removable computing device 104 may include a physical communication interface 204. The physical communication interface may be an interface that is configured to couple with the point of sale device 102 via a coupling 206 and communicate with the point of sale device 102 via the coupling. The physical communication interface 204 may utilize any type of coupling interface and communication protocol suitable for performing the functions disclosed 206 herein, such as universal serial bus. The physical communication interface 204 may be configured to transmit and/or receive data via the coupling 206 with the point of sale device 102.

The removable computing device 104 may also include a processing unit 202. The processing unit 202 may be configured to perform processing functions of the removable computing device 104 that may be suitable for performing the functions disclosed herein. The processing unit 202 may be configured to identify data received by the physical communication interface 204 and generate data requests for transmitting to the point of sale device 102 via the physical communication interface 204 and coupling 206. The processing unit 202 may also be configured to transmit instructions to a wireless communication interface 208 of the removable computing device 104.

The wireless communication interface 208 may be an interface suitable for wirelessly communicating with the external computing device 106 or other device external to the removable computing device 104. The wireless communication interface 208 may include a receiving unit 210 and transmitting unit 212. The receiving unit 210 may be configured to receive data via a wireless network using one or more wireless networking protocols. The transmitting unit 212 may be configured to transmit data via a wireless network using one or more wireless networking protocols. In some embodiments, the receiving unit 210 and transmitting unit 212 may be configured to operate using at least one of: Wi-Fi, Bluetooth, Bluetooth low energy, ZigBee, Z-Wave, and wireless universal serial bus (USB).

The receiving unit 210 may be configured to detect the external computing device 106. Detection of the external computing device 106 may include detecting a signal transmitted by the external computing device 106 over a wireless network. In some embodiments, the signal transmitted by the external computing device 106 may be transmitted upon an instruction given to the external computing device 106 by a user of the external computing device 106. In other embodiments, the transmitting unit 212 may transmit a signal requesting communication to be received by the external computing device 106, upon which the external computing device 106 may transmit the signal to be received by the receiving unit 210.

After communication with the external computing device 106 is established, the processing unit 202 may be configured to generate a request for payment details. The request for payment details may include transaction data associated with the payment transaction, such as a transaction identifier, device identifier, and/or any other suitable data as will be apparent to persons having skill in the relevant art. The transaction identifier may be a unique value suitable for identification of the transaction. The device identifier may be a unique value suitable for identification of the removable computing device 104 and/or the point of sale device 102, such as a media access control address or internet protocol address. The request for payment details may be transmitted to the external computing device 106 via the transmitting unit 212 of the wireless communication interface 208.

The receiving unit 210 of the wireless communication interface 208 may be configured to receive payment details from the external computing device 106. In some embodiments, the payment details may be accompanied by additional information, such as authentication information used to authenticate a user of the external computing device. The payment details may include any data suitable for use by the point of sale device 102 for funding a payment transaction using an associated payment account, such as an account number, a cryptogram, etc. The payment details may then be transmitted to the point of sale device 102 via the physical communication interface 204 and coupling 206. In embodiments where authentication information is received, the authentication information may also be transmitted to the point of sale device 102.

In some embodiments, the processing unit 202 may be configured to format the received payment details in a format suitable for use by the point of sale device 102. For instance, the processing unit 202 may be configured to format the payment details for inclusion in an authorization request pursuant to ISO 8583. In some instances, the processing unit 202 may be configured to generate an authorization request for the payment transaction including the payment details. In such an instance, the generated authorization request may be transmitted to the point of sale device 102 for transmission to the processing server 110 of the payment network 108 for processing using traditional methods and systems.

In some embodiments, the receiving unit 210 of the wireless communication interface 208 may be configured to receive data from the processing server 110 of the payment network 108 over one or more networks. In one embodiment, the wireless communication interface 208 may communicate with the processing server 110 over a different network than one used to communicate with the external computing device 106. The receiving unit 210 may be configured to receive the payment details for the payment transaction from the processing server 110. The receiving unit 210 may also be configured to receive authentication information from the processing server 110.

In some embodiments, the receiving unit 210 may receive authentication information from both the external computing device 106 and the processing server 110. In such an embodiment, the processing unit 202 may be configured to compare the received authentication information to verify the authenticity of a user of the external computing device 106 as an authorized user of the payment account associated with the received payment details.

The removable computing device 104 may also include a memory 214. The memory 214 may be configured to store data suitable for performing the functions disclosed herein. For instance, the memory 214 may be configured to store rules regarding formatting received payment details and generating authorization requests. Data that may be stored in the memory 214 may be apparent to persons having skill in the relevant art.

### Processing Contactless Payment Transactions at a Traditional Point of Sale

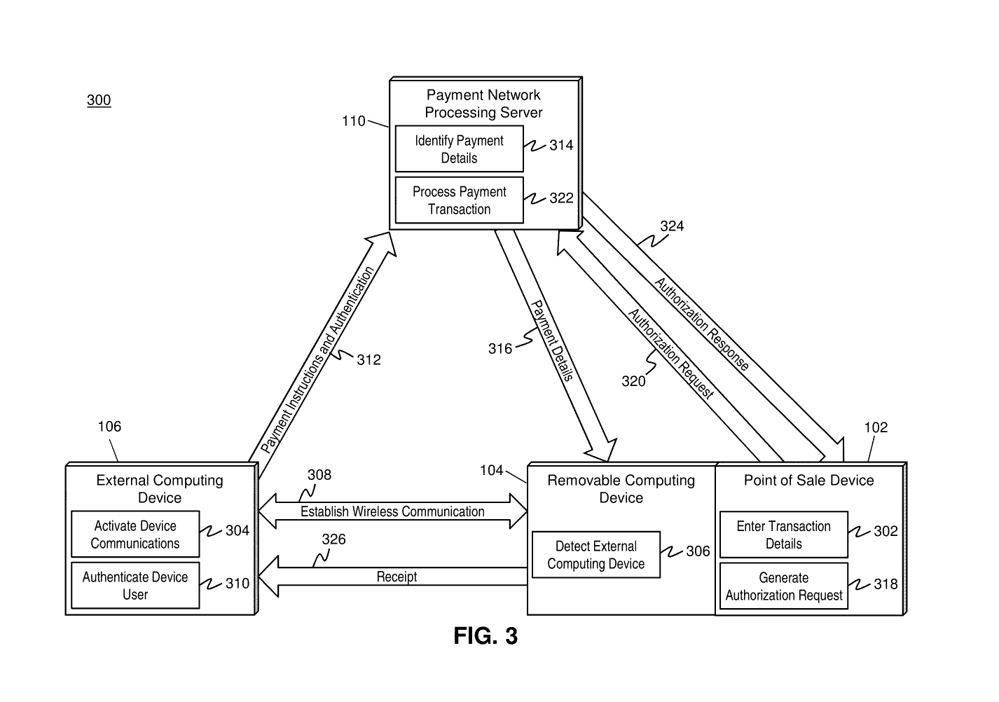

FIG. 3 illustrates a process 300 for processing a contactless payment transaction at a traditional point of sale device 102 removable coupled with the removable computing device 104.

In step 302, a user of the point of sale device 102 may enter transaction details for a payment transaction into the point of sale device 102. The transaction details may be entered via methods and systems that will be apparent to persons having skill in the relevant art, such as via manual input using an input device (e.g., a keyboard), via reading bar codes encoded with product data, etc. In step 304, wireless communications may be activated on the external computing device 106. The wireless communications may be activated by a user of the external computing device 106 or by the transmitting of a signal from the removable computing device 104 via a wireless network. In one instance, the external computing device 106 may be a passive device configured to operate upon receipt of a signal from the removable computing device 106.

In step 306, the wireless communication interface 208 of the removable computing device 104 may detect the external computing device 106. In step 308, wireless communication may be established between the external computing device 106 and the removable computing device 104 using one or more wireless communication networks and protocols. In some embodiments, the wireless communication may be performed using short distance communication protocols.

In step 310, the external computing device 106 may authenticate a user of the external computing device 106. Methods and systems suitable for authenticating a user of an external computing device 106 will be apparent to persons having skill in the relevant art and may include input of personal identification numbers, reading of biometric data, etc. Step 310 may also include the selection of payment instructions by the user of the external computing device 106 if necessary. For instance, the user may select a payment account from a plurality of payment accounts for use in funding the payment transaction. In step 312, the authentication information and instructions for payment may be transmitted to the processing server 110 of the payment network 108. In an exemplary embodiment, the authentication information and payment instructions may be transmitted to the processing server 110 using a different network than the network used for wireless communications with the removable computing device 104, such as a cellular communication network.

In step 314, the processing server 110 may identify payment details to be used for funding the payment transaction based on the received payment instructions. In some embodiments, the payment details may only be identified upon successful authentication of the user of the external computing device 106 based on the received authentication information. In step 316, the identified payment details may be transmitted to the removable computing device 104. The receiving unit 210 of the wireless communication interface 208 may receive the payment details, which may be formatted by the processing unit 202 and transmitted to the point of sale device 102 via the physical communication interface 204.

In step 318, the point of sale device 102 may generate an authorization request for the payment transaction, with the authorization request including the payment details, using methods and systems that will be apparent to persons having skill in the relevant art. In step 320, the authorization request may be submitted to the processing server 110 using traditional systems and methods. In some embodiments, transaction data for the payment transaction and the payment details may be first transmitted to an acquirer associated with the point of sale device 102 for inclusion in an authorization request submitted to the processing server 110.

In step 322, the processing server 110 may process the payment transaction using methods and systems that will be apparent to persons having skill in the relevant art. In step 324, an authorization response indicating approval or denial of the payment transaction may be transmitted back to the point of sale device 102 (e.g., via an acquirer). The point of sale device 102 may receive the authorization response and may finalize the payment transaction. In one embodiment, the removable computing device 104 may transmit a receipt to the external computing device 106 for an approved payment transaction using the established wireless communication, in step 326.

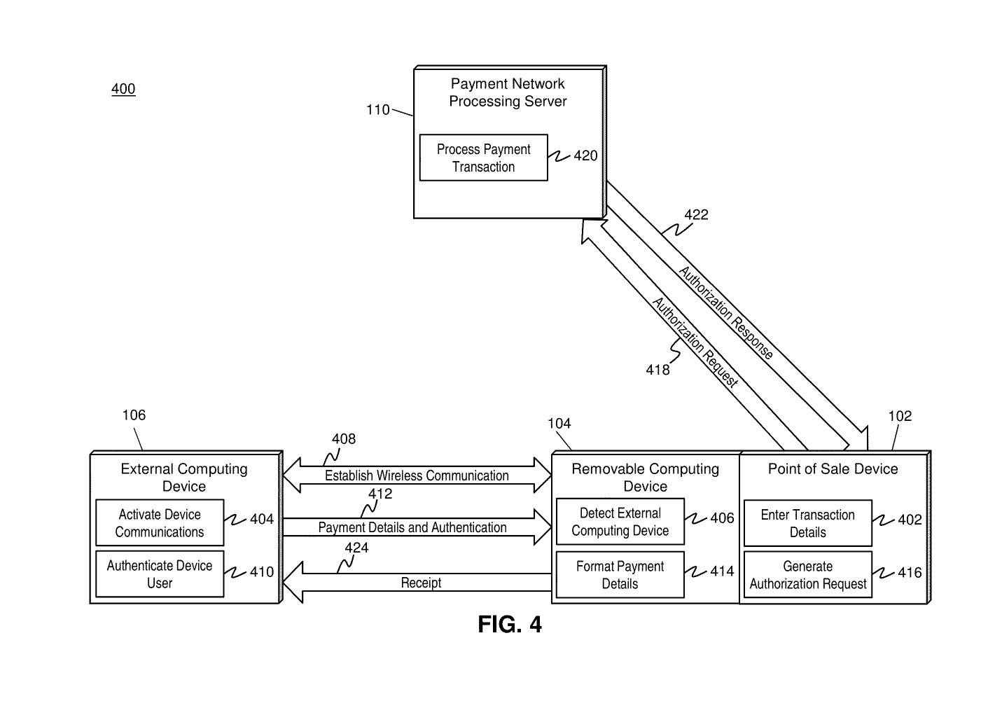

FIG. 4 illustrates an alternative process 400 for processing a contactless payment transaction using the traditional point of sale device 102.

In the alternative process 400, the transaction details may be entered into the point of sale device 102 in step 402, and, in step 404, the wireless communications of the external computing device 106 may be activated. In step 406, the removable computing device 104 may detect the external computing device 106, and, in step 408, may establish wireless communication with the external computing device 106.

In step 410, the external computing device 106 may authenticate a user of the external computing device 106 using methods and systems that will be apparent to persons having skill in the relevant art. The user of the external computing device 106 may also identify a payment account to be used in funding the payment transaction. In step 412, payment details associated with the identified payment account may be transmitted, along with authentication information, to the removable computing device 104 using the established communication. The payment details and authentication information may be received by the receiving unit 210 using the wireless communication interface 208.

In step 414, the processing unit 202 may format the payment details prior to transmission to the point of sale device 102 via the coupling 206 using the physical communication interface 204. In some embodiments, the payment details received from the external computing device 106 may be encrypted. In such an embodiment, step 414 may include decryption of the encrypted payment details. Methods for decrypting payment details received from an external computing device 106 will be apparent to persons having skill in the relevant art.

In step 416, the point of sale device 102 may generate an authorization request including the formatted payment details, as well as the authentication information if applicable, and submit the authorization request to the processing server 110, in step 418. In step 420, the processing server 110 may process the payment transaction using methods and systems that will be apparent to persons having skill in the relevant art, and may transmit an authorization response indicating approval or denial of the payment transaction to the point of sale device 102, in step 422. In step 424, the removable computing device 106 may transmit a receipt to the external computing device 106 using the established wireless communication.

### Methods for Processing Contactless Payment Transactions at a Traditional Point of Sale

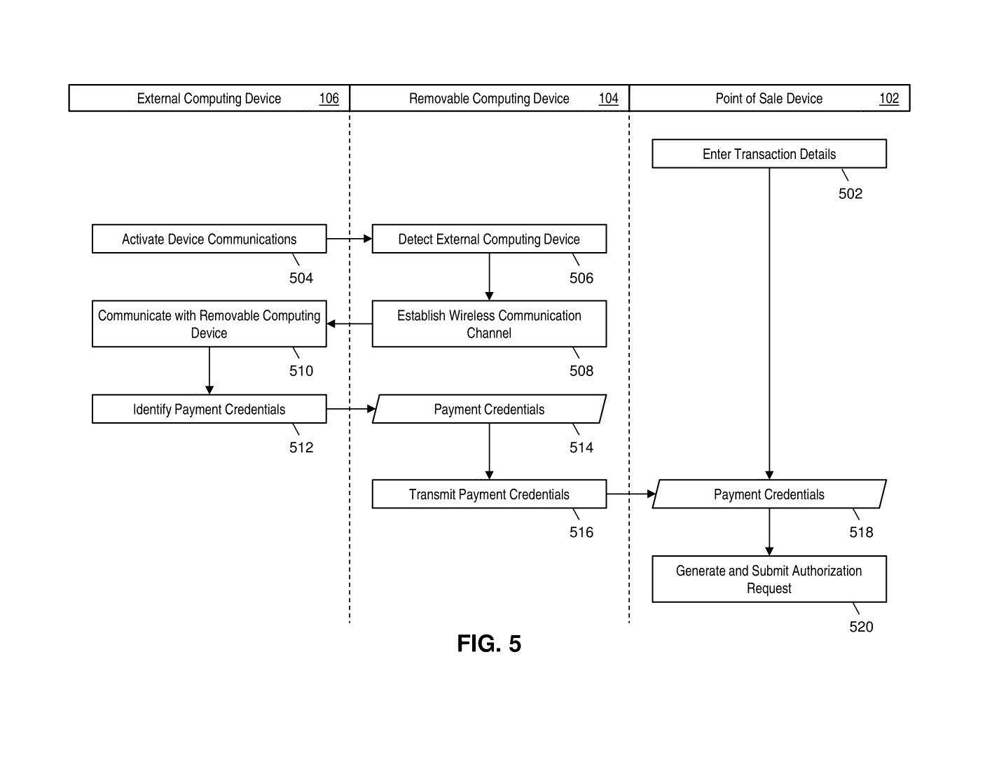

FIG. 5 illustrates a method for processing contactless payment transactions using a traditional point of sale device 102, where payment credentials may be communicated between the external computing device 106 and the removable computing device 104.

In step 502, transaction details for a payment transaction may be entered into the point of sale device 102 using methods and systems that will be apparent to persons having skill in the relevant art. In step 504, device communications of the external computing device 106 may be activated. In one embodiment, a user of the external computing device 106 may activate the device communications. In another embodiment, the device communications may be activated by the removable computing device 104.

In step 506, the removable computing device 104 may detect the external computing device 106, such as based on transmissions made by the external computing device 106 upon activation of the device communications. In step 508, a wireless communication channel may be established with the external computing device 106 by the removable computing device 104. In one embodiment, the establishing of the wireless communication channel may include transmitting of transaction data for the payment transaction to the external computing device 106.

In step 510, the external computing device 106 may receive data from the removable computing device 104 via the established wireless communications, such as the transaction data. In step 512, the external computing device 106 may identify payment credentials to be used to fund the payment transaction. In one embodiment, a user of the external computing device 106 may select payment credentials to be used. In another embodiment, the external computing device 106 may automatically identify the payment credentials, such as based on the received transaction data and one or more rules. The identified payment credentials may then be transmitted to the removable computing device 104 via the established wireless communication channel, and received by the removable computing device 104, in step 514.

In step 516, the received payment credentials may be transmitted to the point of sale device 102 via the coupling 206. The point of sale device 102 may receive the payment credentials, in step 518, and, in step 520, may generate an authorization request for the payment transaction including the payment credentials using methods and systems that will be apparent to persons having skill in the relevant art, and may submit the authorization request to the processing server 110 for processing.

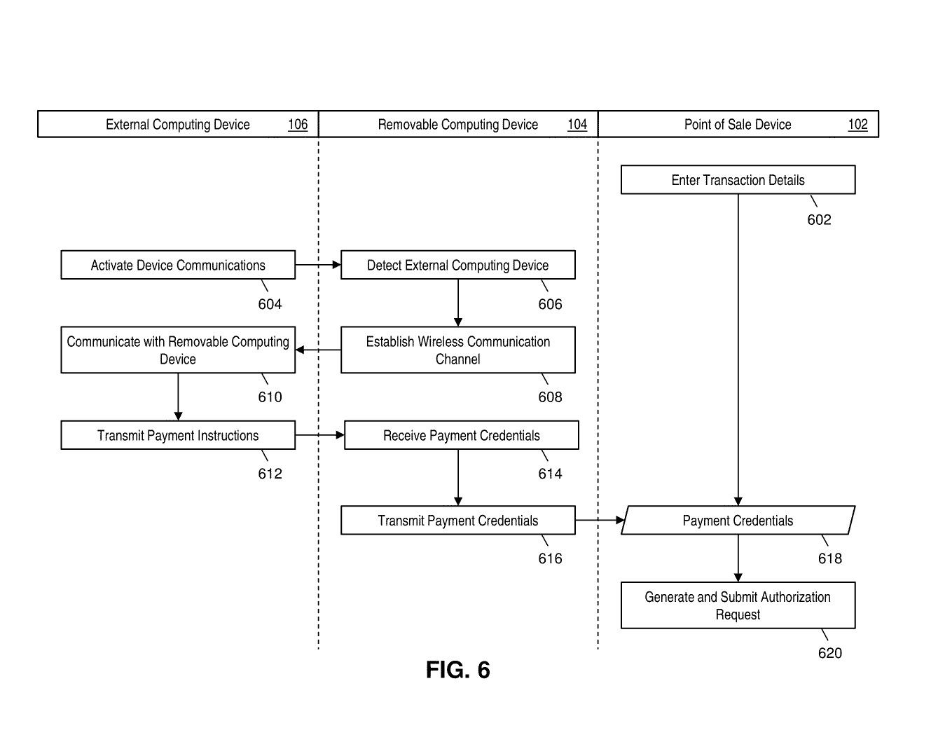

FIG. 6 illustrates an alternative method for processing contactless payment transactions using the traditional point of sale device 102 where payment credentials may be communicated from the processing server 110 to the removable computing device 104.

In the method illustrated in FIG. 6, steps 602 to 610 may correspond to steps 502 to 510 for initiating the payment transaction and establishing wireless communication between the removable computing device 104 and the external computing device 106. In one embodiment, steps 608 and 610 for establishing the wireless communication channel may include transmitting transaction data for the payment transaction to the external computing device 106.

In step 612, the external computing device 106 may transmit payment instructions for the payment transaction to the processing server 110. The payment instructions may include selection of a payment account to be used to fund the payment transaction, such as made by a user of the external computing device 106. The transmitted payment instructions may also include the transaction data provided by the removable computing device 104. In one embodiment, the transaction data may include a device identifier associated with the removable computing device 104.

The processing server 110 may identify payment credentials for the payment account selected by the user of the external computing device 106 and may, in step 614, transmit the identified payment credentials to the removable computing device 104 using a communication channel other than the channel established between the removable computing device 104 and the external computing device 106. In some embodiments, the processing server 110 may identify the removable computing device 104 for transmission of the payment credentials via the transaction data (e.g., the device identifier) provided by the removable computing device 104 to the external computing device 106 and included in the payment instructions. In some embodiments, the processing server 110 may pre-authorize the payment transaction prior to transmission of the payment credentials, based on the received transaction data.

In step 616, the removable computing device 104 may transmit the payment credentials received from the processing server 110 to the point of sale device 102. In some embodiments, the processing unit 202 of the removable computing device 104 may first decrypt the payment credentials and/or format the payment credentials for use by the point of sale device 102. In step 618, the point of sale device 102 may receive the payment credentials, and may, in step 620, generate and submit an authorization request for the payment transaction including the payment credentials to the processing server 110. In embodiments where the payment transaction may be pre-authorized by the processing server 110, the authorization request submitted to the processing server 110 may indicate the pre-authorization.

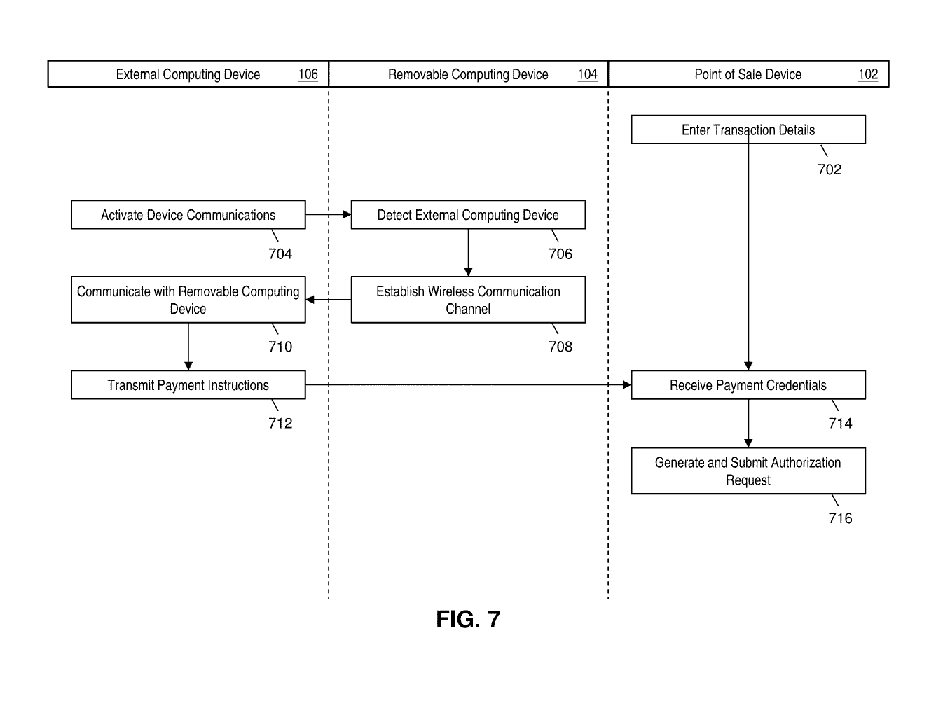

FIG. 7 illustrates an alternative method for processing contactless payment transactions using the traditional point of sale device 102 where payment credentials may be communicated from the external computing device 106 to the point of sale device 102 following the establishing of communication between the external computing device 106 and the removable computing device 104.

In the method illustrated in FIG. 7, steps 702 to 710 may correspond to steps 502 to 510 for initiating the payment transaction and establishing wireless communication between the removable computing device 104 and the external computing device 106. In one embodiment, steps 708 and 710 for establishing the wireless communication channel may include transmitting identification data suitable for communicating with the point of sale device 102 to the external computing device 106. Identification data may include a device identifier (e.g., a media access control address) associated with the point of sale device 102 and other suitable information, such as a network identifier and credentials suitable for establishing communication with the point of sale device 102.

In step 712, the external computing device 106 may identify payment credentials and may transmit the identified payment credentials to the point of sale device 102 based on the received identification data. In step 714, the point of sale device 102 may receive the payment credentials, and may decrypt or otherwise process the payment credentials as necessary. In step 716, the point of sale device 102 may generate and submit an authorization request to the processing server 110 including the received payment credentials.

In such an embodiment as illustrated in FIG. 7, the removable computing device 104 may be used to establish communication between the external computing device 106 and a traditional point of sale device 102 that may otherwise be unavailable. For example, the point of sale device 102 may be configured to communicate with a Wi-Fi network, such as part of a merchant point of sale system, but may be unable to detect and establish communications with the external computing device 106. In such an embodiment, the removable computing device 104 may be used to detect and identify the external computing device 106 and provide data suitable for enabling the external computing device 106 to provide payment credentials to the point of sale device 102, without requiring modification of the point of sale device 102.

### First Exemplary Method for Processing a Contactless Payment Transaction Using a Traditional Point of Sale

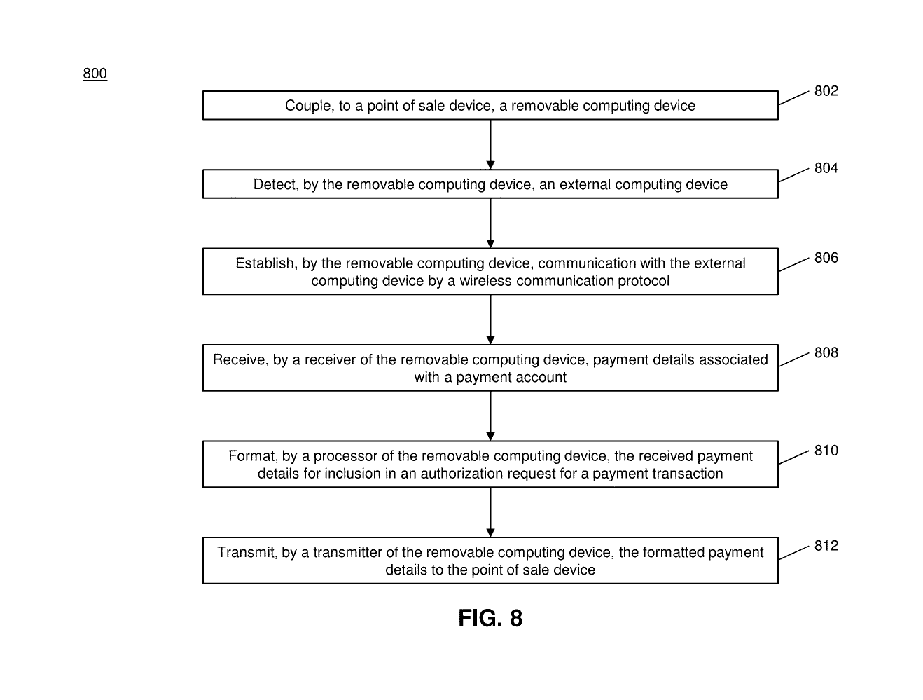

FIG. 8 illustrates a method 800 for processing a contactless payment transaction using a traditional point of sale via a removable computing device.

In step 802, a removable computing device (e.g., the removable computing device 104) may be coupled (e.g., via coupling 206) to a point of sale device (e.g., the point of sale device 102). In step 804, an external computing device (e.g., the external computing device 106) may be detected by the removable computing device 104. In one embodiment, the external computing device 106 may be at least one of: a cellular phone, smart phone, tablet computer, laptop computer, notebook computer, and a wearable computing device. In step 806, communication with the external computing device 106 may be established by the removable computing device 104 by a wireless communication protocol. In some embodiments, the wireless communication protocol may be at least one of: Wi-Fi, Bluetooth, Bluetooth low energy, ZigBee, Z-Wave, and Wireless USB.

In step 808, payment details associated with a payment account may be received by a receiver (e.g., the receiving unit 210) of the removable computing device 104. In one embodiment, the payment details may be received from an additional computing device (e.g., the processing server 110). In some embodiments, the payment details are received from one of: the external computing device 106 and an additional external computing device (e.g., the processing server 110) when prompted by the external computing device 106.

In step 810, the received payment details may be formatted, by a processor (e.g., the processing unit 202) of the removable computing device 104 for inclusion in an authorization request for a payment transaction. In step 812, the formatted payment details may be transmitted, by a transmitter (e.g., the transmitting unit 212) of the removable computing device 104, to the point of sale device 102.

In one embodiment, the method 800 may further include generating, by the processor 202 of the removable computing device 104, an authorization request for the payment transaction, where the authorization request includes the formatted payment details, wherein transmitting the payment details to the point of sale device 102 includes transmitting the authorization request including the formatted payment details to the point of sale device 102. In some embodiments, the method 800 may further include: receiving, via the established communication, authentication data from the external computing device 106; and transmitting, by the transmitter 212 of the removable computing device 104, the received authentication data to the point of sale device 102.

### Second Exemplary Method for Processing a Contactless Payment Transaction Using a Traditional Point of Sale

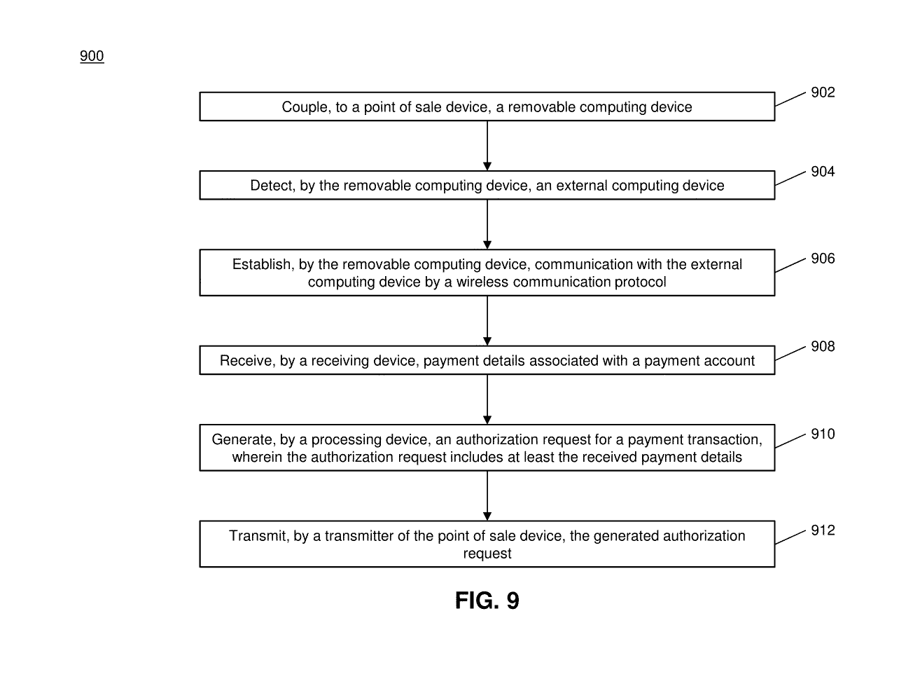

FIG. 9 illustrates an alternative method 900 for processing a contactless payment transaction using a traditional point of sale via a removable computing device.

In step 902, a removable computing device (e.g., the removable computing device 104) may be coupled (e.g., via coupling 206) to a point of sale device (e.g., the point of sale device 102). In step 904, an external computing device (e.g., the external computing device 106) may be detected by the removable computing device 104. In one embodiment, the external computing device 106 may be at least one of: a cellular phone, smart phone, tablet computer, laptop computer, notebook computer, and a wearable computing device.

In step 906, communication with the external computing device 106 by a wireless communication protocol may be established by the removable computing device 104. In some embodiments, the wireless communication protocol may be at least one of: Wi-Fi, Bluetooth, Bluetooth low energy, ZigBee, Z-Wave, and Wireless USB. In step 908, payment details associated with a payment account may be received by a receiving device. In some embodiments, the received payment details may be received from one of: the external computing device 106 and a second external computing device (e.g., the processing server 110). In one embodiment, the receiving device may be included in the point of sale device 102 and the payment details may be received from a second external computing device (e.g., the processing server 110).

In step 910, an authorization request for a payment transaction may be generated, by a processing device, wherein the authorization request includes at least the received payment details. In step 912, the generated authorization request may be transmitted by a transmitter of the point of sale device 102. In one embodiment, the method 900 may further include: receiving, via the established communication, authentication data from the external computing device 106; and transmitting, by a transmitter (e.g., the transmitting unit 212) of the removable computing device 104, the received authentication data to the point of sale device.

### Computer System Architecture

FIG. 10 illustrates a computer system 1000 in which embodiments of the present disclosure, or portions thereof, may be implemented as computer-readable code. For example, the removable computing device 104 and point of sale device 102 of FIG. 1 may be implemented in the computer system 1000 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-9.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1018, a removable storage unit 1022, and a hard disk installed in hard disk drive 1012.

Various embodiments of the present disclosure are described in terms of this example computer system 1000. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1004 may be a special purpose or a general purpose processor device. The processor device 1004 may be connected to a communications infrastructure 1006, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1000 may also include a main memory 1008 (e.g., random access memory, read-only memory, etc.), and may also include a secondary memory 1010. The secondary memory 1010 may include the hard disk drive 1012 and a removable storage drive 1014, such as a floppy disk drive, a magnetic tape drive, an optical disk drive, a flash memory, etc.

The removable storage drive 1014 may read from and/or write to the removable storage unit 1018 in a well-known manner. The removable storage unit 1018 may include a removable storage media that may be read by and written to by the removable storage drive 1014. For example, if the removable storage drive 1014 is a floppy disk drive or universal serial bus port, the removable storage unit 1018 may be a floppy disk or portable flash drive, respectively. In one embodiment, the removable storage unit 1018 may be non-transitory computer readable recording media.

In some embodiments, the secondary memory 1010 may include alternative means for allowing computer programs or other instructions to be loaded into the computer system 1000, for example, the removable storage unit 1022 and an interface 1020. Examples of such means may include a program cartridge and cartridge interface (e.g., as found in video game systems), a removable memory chip (e.g., EEPROM, PROM, etc.) and associated socket, and other removable storage units 1022 and interfaces 1020 as will be apparent to persons having skill in the relevant art.

Data stored in the computer system 1000 (e.g., in the main memory 1008 and/or the secondary memory 1010) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1000 may also include a communications interface 1024. The communications interface 1024 may be configured to allow software and data to be transferred between the computer system 1000 and external devices. Exemplary communications interfaces 1024 may include a modem, a network interface (e.g., an Ethernet card), a communications port, a PCMCIA slot and card, etc. Software and data transferred via the communications interface 1024 may be in the form of signals, which may be electronic, electromagnetic, optical, or other signals as will be apparent to persons having skill in the relevant art. The signals may travel via a communications path 1026, which may be configured to carry the signals and may be implemented using wire, cable, fiber optics, a phone line, a cellular phone link, a radio frequency link, etc.

The computer system 1000 may further include a display interface 1002. The display interface 1002 may be configured to allow data to be transferred between the computer system 1000 and external display 1030. Exemplary display interfaces 1002 may include high-definition multimedia interface (HDMI), digital visual interface (DVI), video graphics array (VGA), etc. The display 1030 may be any suitable type of display for displaying data transmitted via the display interface 1002 of the computer system 1000, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 1008 and secondary memory 1010, which may be memory semiconductors (e.g., DRAMs, etc.). These computer program products may be means for providing software to the computer system 1000. Computer programs (e.g., computer control logic) may be stored in the main memory 1008 and/or the secondary memory 1010. Computer programs may also be received via the communications interface 1024. Such computer programs, when executed, may enable computer system 1000 to implement the present methods as discussed herein. In particular, the computer programs, when executed, may enable processor device 1004 to implement the methods illustrated by FIGS. 3-9, as discussed herein. Accordingly, such computer programs may represent controllers of the computer system 1000. Where the present disclosure is implemented using software, the software may be stored in a computer program product and loaded into the computer system 1000 using the removable storage drive 1014, interface 1020, and hard disk drive 1012, or communications interface 1024.

Techniques consistent with the present disclosure provide, among other features, systems and methods for processing contactless payment transactions using traditional points of sale. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for processing a contactless payment transaction using a traditional point of sale, comprising:
coupling, to a point of sale device, a removable computing device;
detecting, by the removable computing device, an external computing device;
establishing, by the removable computing device, communication with the external computing device by a wireless communication protocol;
receiving, by a receiver of the removable computing device, payment details associated with a payment account;
formatting, by a processor of the removable computing device, the received payment details for inclusion in an authorization request for a payment transaction; and
transmitting, by a transmitter of the removable computing device, the formatted payment details to the point of sale device.

2. The method of claim 1, wherein the payment details are received from an additional computing device.

3. The method of claim 1, further comprising:
generating, by the processor of the removable computing device, an authorization request for the payment transaction, where the authorization request includes the formatted payment details, wherein
transmitting the formatted payment details to the point of sale device includes transmitting the authorization request including the formatted payment details to the point of sale device.

4. The method of claim 1, wherein the payment details are received from one of: the external computing device and an additional external computing device when prompted by the external computing device.

5. The method of claim 1, wherein the wireless communication protocol is at least one of: Wi-Fi, Bluetooth, Bluetooth low energy, ZigBee, Z-Wave, and Wireless Universal Serial Bus.

6. The method of claim 1, wherein the external computing device is at least one of: a cellular phone, smart phone, tablet computer, laptop computer, notebook computer, and a wearable computing device.

7. The method of claim 1, further comprising:
receiving, via the established communication, authentication data from the external computing device; and
transmitting, by the transmitter of the removable computing device, the received authentication data to the point of sale device.

8. A method for processing a contactless payment transaction using a traditional point of sale, comprising:
coupling, to a point of sale device, a removable computing device;
detecting, by the removable computing device, an external computing device;
establishing, by the removable computing device, communication with the external computing device by a wireless communication protocol;
receiving, by a receiving device, payment details associated with a payment account;
generating, by a processing device, an authorization request for a payment transaction, wherein the authorization request includes at least the received payment details; and
transmitting, by a transmitter of the point of sale device, the generated authorization request.

9. The method of claim 8, wherein the receiving device is included in the point of sale device and the received payment details are received from a second external computing device.

10. The method of claim 8, wherein the received payment details are received from one of: the external computing device and a second external computing device.

11. The method of claim 8, wherein the wireless communication protocol is at least one of: Wi-Fi, Bluetooth, Bluetooth low energy, ZigBee, Z-Wave, and Wireless Universal Serial Bus.

12. The method of claim 8, wherein the external computing device is at least one of: a cellular phone, smart phone, tablet computer, laptop computer, notebook computer, and a wearable computing device.

13. The method of claim 8, further comprising:
receiving, via the established communication, authentication data from the external computing device; and
transmitting, by a transmitter of the removable computing device, the received authentication data to the point of sale device.

14. A system for processing a contactless payment transaction using a traditional point of sale, comprising:
a point of sale device;
a removable computing device coupled to the point of sale device, wherein the removable computing device is configured to
detect an external computing device, and
establish communication with the external computing device by a wireless communication protocol, and wherein
the removable computing device includes
a receiver configured to receive payment details associated with a payment account,
a processor configured to format the received payment details for inclusion in an authorization request for a payment transaction, and
a transmitter configured to transmit the formatted payment details to the point of sale device.

15. The system of claim 14, wherein the payment details are received from an additional computing device.

16. The system of claim 14, wherein
the processor of the removable computing device is further configured to generate an authorization request for the payment transaction, where the authorization request includes the formatted payment details, and
transmitting the formatted payment details to the point of sale device includes transmitting the authorization request including the formatted payment details to the point of sale device.

17. The system of claim 14, wherein the payment details are received from one of: the external computing device and an additional external computing device when prompted by the external computing device.

18. The system of claim 14, wherein the wireless communication protocol is at least one of: Wi-Fi, Bluetooth, Bluetooth low energy, ZigBee, Z-Wave, and Wireless Universal Serial Bus.

19. The system of claim 14, wherein the external computing device is at least one of: a cellular phone, smart phone, tablet computer, laptop computer, notebook computer, and a wearable computing device.

20. The system of claim 14, wherein
the removable computing device is further configured to receive, via the established communication, authentication data from the external computing device, and
the transmitter of the removable computing device is further configured to transmit the received authentication data to the point of sale device.

21. A system for processing a contactless payment transaction using a traditional point of sale, comprising:
a point of sale device;
a removable computing device coupled to the point of sale device configured to
detect an external computing device, and
establish communication with the external computing device by a wireless communication protocol;
a receiving device configured to receive payment details associated with a payment account; and
a processing device configured to generate an authorization request for a payment transaction, wherein the authorization request includes at least the received payment details; wherein
the point of sale device includes a transmitter configured to transmit the generated authorization request.

22. The system of claim 21, wherein the receiving device is included in the point of sale device and the received payment details are received from a second external computing device.

23. The system of claim 21, wherein the received payment details are received from one of: the external computing device and a second external computing device.

24. The system of claim 21, wherein the wireless communication protocol is at least one of: Wi-Fi, Bluetooth, Bluetooth low energy, ZigBee, Z-Wave, and Wireless Universal Serial Bus.

25. The system of claim 21, wherein the external computing device is at least one of: a cellular phone, smart phone, tablet computer, laptop computer, notebook computer, and a wearable computing device.

26. The system of claim 21, wherein
the removable computing device is further configured to receive, via the established communication, authentication data from the external computing device, and
the removable computing device includes a transmitter configured to transmit the received authentication data to the point of sale device.
